(19) United States
(12) Patent Application Publication
(10) Pub. No.: US 2023/0370850 A1
(43) Pub. Date: Nov. 16, 2023

(54) INTELLIGENT UNLOCKING METHOD, APPARATUS, DEVICE AND STORAGE MEDIUM

(71) Applicant: HOLITECH TECHNOLOGY AMERICA, INC., Santa Clara, CA (US)

(72) Inventors: Xiaobing MAO, Santa Clara, CA (US); Songjin YAO, Santa Clara, CA (US); Lun WANG, Santa Clara, CA (US)

(73) Assignee: HOLITECH TECHNOLOGY AMERICA, INC., Santa Clara, CA (US)

(21) Appl. No.: 17/743,877

(22) Filed: May 13, 2022

(51) Int. Cl. H04W 12/50; H04W 4/80; H04W 76/10; H04W 12/61; H04W 12/06

(52) U.S. Cl. CPC H04W 12/50; H04W 4/80; H04W 76/10; H04W 12/61; H04W 12/06

(57) ABSTRACT

Disclosed are an intelligent unlocking method, an apparatus, a device and a storage medium. The method includes: waking up a Bluetooth module and broadcasting a Bluetooth signal upon receiving an unlocking instruction; determining whether a terminal device receiving the Bluetooth signal is a terminal device paired with the Bluetooth module successfully within a preset time period; and in responding to that the terminal device receiving the Bluetooth signal is the terminal device paired with the Bluetooth module successfully within the preset time period, establishing a Bluetooth connection with the terminal device, and changing the Bluetooth module to a sleep state after a Bluetooth lock is opened.

### TECHNICAL FIELD

The present application relates to a technical filed of information security, in particular to an intelligent unlocking method, an intelligent unlocking apparatus, a device and a storage medium.

### BACKGROUND

At present, with the gradual maturity of Bluetooth technology, smart locks in the market adopt Bluetooth unlocking mode. Bluetooth smart locks are equipped with corresponding app of the mobile phone. When the user unlocks, the Bluetooth module of the mobile phone is connected with the Bluetooth smart lock, and then an app of the mobile phone is used to control unlocking.

In the related art, in order to make the mobile phone detect the Bluetooth signal, the internal Bluetooth module of the Bluetooth smart lock needs to broadcast the Bluetooth signal all the time, even when the user has no need to unlock, the Bluetooth smart lock also broadcasts all the time, and the Bluetooth smart lock consumes more power and wastes power resources.

The above content is only used to assist in understanding the technical solution of the present application, and does not mean that the above content is recognized as the related art.

### SUMMARY

The main purpose of the present application is to provide an intelligent unlocking method, an apparatus, a device and a storage medium, which aims to solve the technical problem that the intelligent lock also broadcasts the Bluetooth signal and consumes more power when the user has no unlocking demand.

In order to achieve the above purpose, the present application provides an intelligent unlocking method, includes:
waking up a Bluetooth module and broadcasting a Bluetooth signal upon receiving an unlocking instruction;
determining whether a terminal device receiving the Bluetooth signal is a terminal device paired with the Bluetooth module successfully within a preset time period; and
in responding to that the terminal device receiving the Bluetooth signal is the terminal device paired with the Bluetooth module successfully within the preset time period, establishing a Bluetooth connection with the terminal device, and changing the Bluetooth module to a sleep state after a Bluetooth lock is opened.

Optionally, an operation of determining whether the terminal device receiving the Bluetooth signal is the terminal device paired with the Bluetooth module successfully within the preset time period, includes:
obtaining device information of the terminal device receiving the Bluetooth signal; and
determining whether the device information is stored in a device information database, wherein the device information database stores device information of terminal devices paired successfully with the Bluetooth module within the preset time period.

Optionally, after an operation of determining whether the terminal device receiving the Bluetooth signal is the terminal device paired with the Bluetooth module successfully within the preset time period, the method further comprises:
in responding to that the terminal device receiving the Bluetooth signal is not the terminal device paired with the Bluetooth module successfully within the preset time period, sending a Bluetooth pairing prompt to the terminal device receiving the Bluetooth signal;
obtaining a pairing password fed back by the terminal device based on the Bluetooth pairing prompt, and verifying the pairing password; and
in responding to that the pairing password is validated, establishing the Bluetooth connection with the terminal device, and storing the device information of the terminal device in the device information database.

Optionally, when the verification is passed, an operation of in responding to that the pairing password is validated, establishing the Bluetooth connection with the terminal device, and storing the device information of the terminal device in the device information database, includes:
in responding to that it is verified that the pairing password is a preset password, establishing the Bluetooth connection with the terminal device and obtaining the device information of the terminal device;
obtaining a number of pieces of device information in the device information database; and
in responding to that the number does not exceed a preset number, storing the device information of the terminal device in the device information database.

Optionally, after an operation of obtaining the number of pieces of device information in the device information database, the method further includes:
in responding to that the number reaches the preset number, obtaining a storing timestamp corresponding to each piece of device information in the device information database;
determining an earliest stored piece of device information according to an order of storing timestamps; and
replacing the earliest stored piece of device information with the device information of the terminal device.

Optionally, an operation of obtaining the pairing password fed back by the terminal device based on the Bluetooth pairing prompt and verifying the pairing password, includes:
obtaining the pairing password fed back by the terminal device based on the Bluetooth pairing prompt;
determining whether the pairing password is a plaintext password; and
verifying the pairing password according to the preset password in responding to that the pairing password is the plaintext password.

Optionally, after an operation of determining whether the pairing password is the plaintext password, the method includes:
in responding to that the pairing password is an encryption password, decrypting the pairing password according to a preset encryption method to obtain the decrypted password, wherein the encryption password is obtained by the terminal device through the preset encryption method; and
verifying the decrypted password according to the preset password.

In addition, in order to achieve the above purpose, the present application provides an intelligent unlocking apparatus, including:
a Bluetooth broadcast module for waking up a Bluetooth module and broadcasting a Bluetooth signal upon receiving an unlocking instruction;
a device determination module for determining whether a terminal device receiving the Bluetooth signal is a terminal device paired with the Bluetooth module successfully within a preset time period;
a connection establishment module for in responding to that the terminal device receiving the Bluetooth signal is the terminal device paired with the Bluetooth module successfully within the preset time period, establishing a Bluetooth connection with the terminal device, and changing the Bluetooth module to a sleep state after a Bluetooth lock is opened.

In addition, in order to achieve the above purpose, the present application provides an intelligent unlocking device, comprising a memory, a processor and an intelligent unlocking program stored in the memory and executable by the processor, the intelligent unlocking program is configured to realize operations of the intelligent unlocking method as mentioned above.

In addition, in order to achieve the above purpose, the present application provides a storage medium, on which an intelligent unlocking program is stored; when the intelligent unlocking program is executed by the processor, operations of the intelligent unlocking method as mentioned above are realized.

In the present application, a Bluetooth is waken up and a Bluetooth signal is broadcast when an unlocking instruction is received; it is determined whether a terminal device receiving the Bluetooth signal belongs to a terminal device paired within a preset time period; and a Bluetooth connection with the terminal device is established when the terminal device receiving the Bluetooth signal is the terminal device paired with the Bluetooth module successfully within the preset time period, and the Bluetooth is adjusted to a sleep state after the Bluetooth lock is opened, such that when the unlocking instruction is not received, the Bluetooth lock is in the sleep state. When the unlocking instruction is received, the Bluetooth of the Bluetooth lock starts to broadcast the Bluetooth signal and establishes a Bluetooth connection with the terminal device. After the Bluetooth lock is opened, the Bluetooth is adjusted to the sleep state to reduce power consumption, so as to save power resources.

### BRIEF DESCRIPTION OF THE DRAWINGS

FIG. 1 is a structural diagram of an intelligent unlocking device in a hardware operation environment according to an embodiment of the present application.

FIG. 2 is a flow diagram of a first embodiment of an intelligent unlocking method of the present application.

FIG. 3 is a flow diagram of a second embodiment of the intelligent unlocking method of the present application.

FIG. 4 is a flow diagram of a third embodiment of the intelligent unlocking method of the present application.

FIG. 5 is a structural block diagram of a first embodiment of an intelligent unlocking apparatus of the present application.

The realization of the purpose, functional features and advantages of the present application will be further described with reference to the attached drawings in combination with the embodiment.

### DETAILED DESCRIPTION OF THE EMBODIMENTS

It should be understood that the specific embodiments described herein are only used to explain the present application and are not used to limit the present application.

Referring to FIG. 1, FIG. 1 is a structural diagram of an intelligent unlocking device in a hardware operation environment according to an embodiment of the present application.

As shown in FIG. 1, the intelligent unlocking device can include: a processor 1001, such as a central processing unit (CPU), a communication bus 1002, a user interface 1003, a network interface 1004 and a memory 1005. The communication bus 1002 is used to realize the connection and communication among these components. The user interface 1003 may include a display and an input unit, such as a keyboard. The user interface 1003 may optionally also include a standard wired interface and a wireless interface. The network interface 1004 may optionally include a standard wired interface and a wireless interface (such as Wireless-Fidelity (Wi-Fi) interface). The memory 1005 may be a high-speed random access memory (RAM) or a stable non-volatile memory (NVM), such as a disk memory. The memory 1005 may optionally be a storage device independent of the aforementioned processor 1001.

Those skilled in the art can understand that the structure shown in FIG. 1 does not constitute a limitation on the intelligent unlocking device, which may include more or fewer components than shown in the figures, or a combination of some components, or different component arrangements.

As shown in FIG. 1, the memory 1005 as a storage medium may include an operation system, a network communication module, a user interface module and an intelligent unlocking program.

In the intelligent unlocking device shown in FIG. 1, the network interface 1004 is mainly used for data communication with a network server. The user interface 1003 is mainly used for data interaction with users. The processor 1001 and the memory 1005 in the intelligent unlocking device of the present application can be set in the intelligent unlocking device. The intelligent unlocking device calls the intelligent unlocking program stored in the memory 1005 through the processor 1001 and executes the intelligent unlocking method provided by the embodiment of the present application.

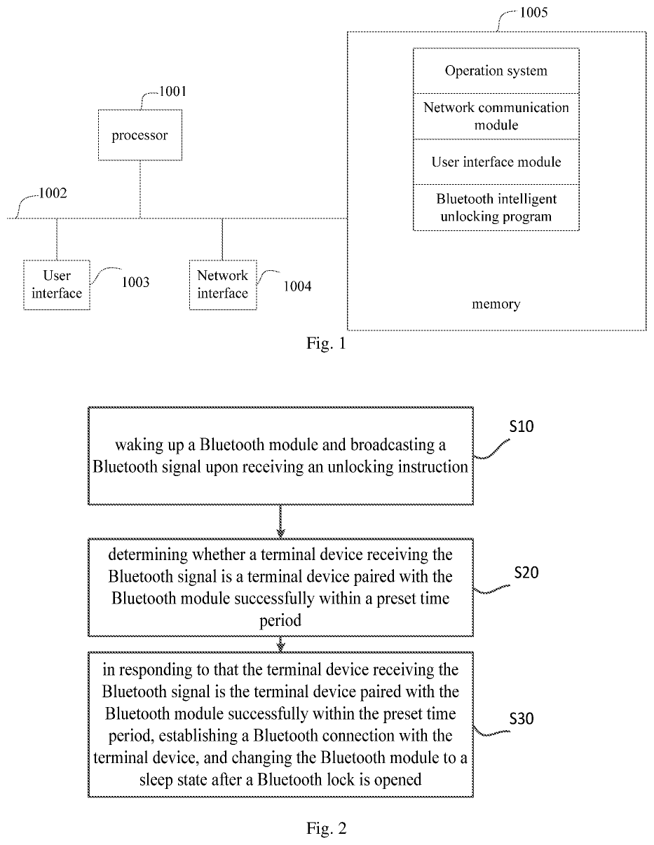

The embodiment of the present application provides an intelligent unlocking method. Referring to FIG. 2, FIG. 2 shows a flow diagram of a first embodiment of the intelligent unlocking method of the present application.

In this embodiment, the intelligent unlocking method includes:

Operation S10, waking up a Bluetooth module and broadcasting a Bluetooth signal upon receiving an unlocking instruction.

It should be noted that the intelligent unlocking method provided in this embodiment can be applied to a scene of using the Bluetooth module for lock and unlock. The executive body of the method of this embodiment can be a Bluetooth lock that can use Bluetooth communication technology to unlock and lock, or another door lock device that can realize the same or similar function. Here, the intelligent unlocking method provided in this embodiment and the following embodiments is described in detail with the above intelligent lock (hereinafter referred to as Bluetooth lock).

It is understandable that the above unlocking instruction can be triggered by the user by executing corresponding operations when there is an unlocking demand. The corresponding operations include but are not limited to: pressing a handle of the Bluetooth lock, touching the unlocking button, rotating the unlocking knob, etc.

It should be understood that the Bluetooth module can be set inside the Bluetooth lock, which can be a traditional Bluetooth module or a low-power Bluetooth module, which is not limited in this embodiment.

It should be noted that in order to facilitate the power supply to the Bluetooth lock, the Bluetooth lock can be directly powered by external or rechargeable battery. When the power is insufficient, the user can charge it or other batteries that can be applied to the Bluetooth lock.

In the specific implementation, when the Bluetooth lock of this embodiment does not receive the unlocking instruction, the Bluetooth is in a sleep state, that is, power supply to the Bluetooth module is stopped. When the unlocking instruction is received, power supply to the Bluetooth module is resumed to wake up the Bluetooth module and broadcast the Bluetooth signal.

Operation S20, determining whether a terminal device receiving the Bluetooth signal is a terminal device paired with the Bluetooth module successfully within a preset time period.

It should be noted that the above terminal device can be a smart phone, a tablet, a smart bracelet/watch, etc., or another portable smart device that can be used to receive Bluetooth signals broadcast by the Bluetooth lock. At the same time, the above terminal device can also be installed with apps corresponding to the Bluetooth lock of this embodiment, and users can also unlock through the apps.

Further, in order to prevent the user from forgetting to carry the terminal device for unlocking, the above Bluetooth lock can also be unlocked through a password, and a password key can be set on the Bluetooth lock.

It can be understood that the device information of the terminal device paired within the above preset time period can be the LAN address (MAC address) of the terminal device, the personal identification number (PIN code), or other information that can be used to indicate the uniqueness of the terminal device, the preset pairing time period can be set by the user. For example, if the user sets the preset pairing time period to 5 days, the Bluetooth lock can only store the device information of the terminal devices paired with the Bluetooth lock within 5 days, so as to improve the security of the Bluetooth lock.

It should be noted that the Bluetooth lock is also provided with a prompt module for prompting the user with a connection status. The prompt module can be an indicator light or other modules that can be used for prompt. The prompt module of the Bluetooth lock in this embodiment is an indicator light. When the Bluetooth lock is not connected with the terminal device, that is, the Bluetooth module is in a broadcasting state, the indicator light flashes slowly at a certain interval. When the Bluetooth lock is successfully connected with the terminal device, the indicator light is always on. After the Bluetooth lock completes the unlocking, the indicator light is turned off, which is conducive to the user to know a working state of the Bluetooth lock in real time.

Further, in order to improve the security of the Bluetooth lock, in this embodiment, the operation S20 in this embodiment include:
obtaining the device information of the terminal device receiving the Bluetooth signal; and
determining whether the device information is stored in a device information database, where the device information database storing device information of terminal devices paired successfully with the Bluetooth lock within the preset time period.

It should be noted that the Bluetooth lock in this embodiment is associated with a device information database, which can be stored in the memory inside of the Bluetooth lock. The device information database stores the device information of the terminal device paired with the Bluetooth lock successfully in the preset time period.

In the specific implementation, the above Bluetooth lock firstly broadcasts the Bluetooth signal. At this time, the indicator of the prompt module flashes slowly at a certain time interval. If a terminal device is detected during broadcasting, the device information of the terminal device receiving the Bluetooth signal is obtained, and the above device information is compared with the device information database inside the Bluetooth lock.

Operation S30, in responding to that the terminal device receiving the Bluetooth signal is the terminal device paired with the Bluetooth module successfully within the preset time period, establishing a Bluetooth connection with the terminal device, and changing the Bluetooth module to a sleep state after a Bluetooth lock is opened.

It should be noted that after the above Bluetooth lock is opened, a current opening time and the device information of the terminal device can also be uploaded to a server, so that the user can also view an opening record of the Bluetooth lock through the app.

In the specific implementation, when the above device information belongs to the device information of the terminal devices paired within the preset time period stored in the device information database, the Bluetooth lock establishes a Bluetooth connection with the terminal device. At this time, the indicator of the prompt module becomes always on. At the same time, the Bluetooth module enters the sleep state after the Bluetooth lock is opened.

In this embodiment, when the unlocking instruction is not received, the Bluetooth module is in the sleep state, that is, power supply to the Bluetooth module is stopped. When the unlocking instruction is received, supply power to the Bluetooth module is resumed to wake up the Bluetooth module to broadcast the Bluetooth signal. At this time, the indicator light of the prompt module flashes slowly at a certain time interval. If the terminal device is detected during broadcasting, the device information of the terminal device receiving the Bluetooth signal is obtained, the device information is compared with the device information database inside the Bluetooth lock. When the device information is the device information of one terminal device paired within the preset time period which is stored in the device information database, the Bluetooth lock establishes a Bluetooth connection with the terminal device. At this time, the indicator light of the prompt module becomes always on. At the same time, after the Bluetooth lock is opened, the Bluetooth module enters the sleep state, so that when the unlocking instruction is not received, the Bluetooth lock is in the sleep state. When the unlocking instruction is received, the Bluetooth module of the Bluetooth lock starts to broadcast the Bluetooth signal and a Bluetooth connection with the terminal device is established. After the Bluetooth lock is opened, the Bluetooth module is changed to the sleep state to reduce power consumption and save power resources.

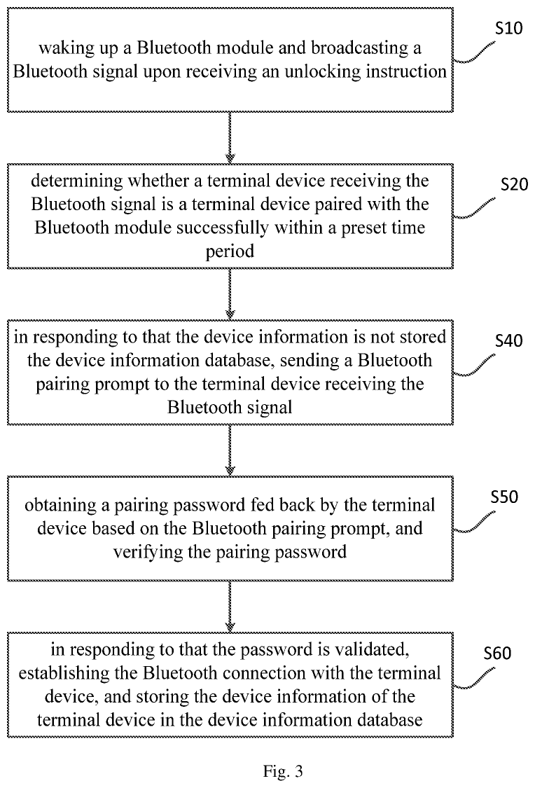

Referring to FIG. 3, FIG. 3 is a flow diagram of a second embodiment of the intelligent unlocking method of the present application.

Based on the above first embodiment, in this embodiment, after the operation S20, the method further includes:

Operation S40, in responding to that the device information is not stored the device information database, sending a Bluetooth pairing prompt to the terminal device receiving the Bluetooth signal.

It should be noted that the above Bluetooth pairing prompt can be a pairing command sent to the terminal device. When the terminal device receives the pairing prompt, a pairing window can be popped up on an interface of the terminal device.

In the specific implementation, considering that the Bluetooth lock needs to add a paired device, when determining that the device information of the above terminal device is not stored in the device information database, the Bluetooth lock sends a Bluetooth pairing prompt to the above terminal device for pairing.

Operation S50, obtaining a pairing password fed back by the terminal device based on the Bluetooth pairing prompt, and verifying the pairing password.

It should be noted that the above pairing password can be obtained according to feedback of the above pairing window popped up on the terminal device. Accordingly, there is a preset password stored in the Bluetooth lock. The preset password can be the PIN code set by the manufacturer when the Bluetooth lock leaves the factory, or set by users themselves during use. This embodiment is not limited to this.

Further, in order to improve the security of the pairing password, the pairing password fed back by the terminal device to the Bluetooth lock can be a plaintext password or an encrypted password.

Accordingly, the above operation S50 includes: obtaining the pairing password fed back by the terminal device based on the Bluetooth pairing prompt;
determining whether the pairing password is a plaintext password; and
verifying the pairing password according to the preset password in responding to that the pairing password is a plaintext password.

It should be noted that if the user doesn't need the encryption, the window sent by the Bluetooth lock to the terminal device is an ordinary window and does not carry an encryption means. In the specific implementation, the Bluetooth lock sends an ordinary window to the terminal device, and the user feeds back the pairing password to the Bluetooth lock through the ordinary window. The Bluetooth lock determines that the pairing password is a plaintext password, and verifies the pairing password according to the preset password.

Further, as another implementation, after the above operations of determining whether the pairing password is a plaintext password, the method further includes: in responding to that the pairing password is an encryption password, decrypting the pairing password according to a preset encryption method, where the encryption password is obtained by the terminal device through the preset encryption method.

It should be noted that the above preset encryption method can be the encryption method set by the user or another encryption method, which is not limited in this embodiment.

In the specific implementation, if the user needs the encryption, the window sent by the Bluetooth lock to the terminal device is an encryption window, which carries a preset encryption means. The user encrypts the pairing password through the encryption window, and then feeds back the encrypted result to the Bluetooth lock. The Bluetooth lock decrypts the feedback result according to the decryption method corresponding to the preset encryption method, to obtain the decrypted password, and then verifies the decrypted password according to the preset password, so as to improve the security of the Bluetooth lock.

Operation S60, in responding to that the password is validated, establishing the Bluetooth connection with the terminal device, and storing the device information of the terminal device in the device information database.

In this embodiment, considering that the Bluetooth lock needs to add a paired device, when that the terminal device receiving the Bluetooth signal does not belong to the preset information database is determined, the Bluetooth lock sends the Bluetooth pairing prompt to the above terminal device for pairing. If the user needs the encryption, the window sent by the Bluetooth lock to the terminal device is the encryption window with the preset encryption means, and the user encrypts the pairing password through the encryption window, then the encrypted result is fed back to the Bluetooth lock. The Bluetooth lock decrypts the feedback result according to the decryption method corresponding to the preset encryption method, to obtain the decrypted password, and then the decrypted password verified according to the preset password. When the verification is passed, the Bluetooth connection with the above terminal device is established, and the device information of the terminal device is stored in the device information database, thus the security of the Bluetooth lock is improved.

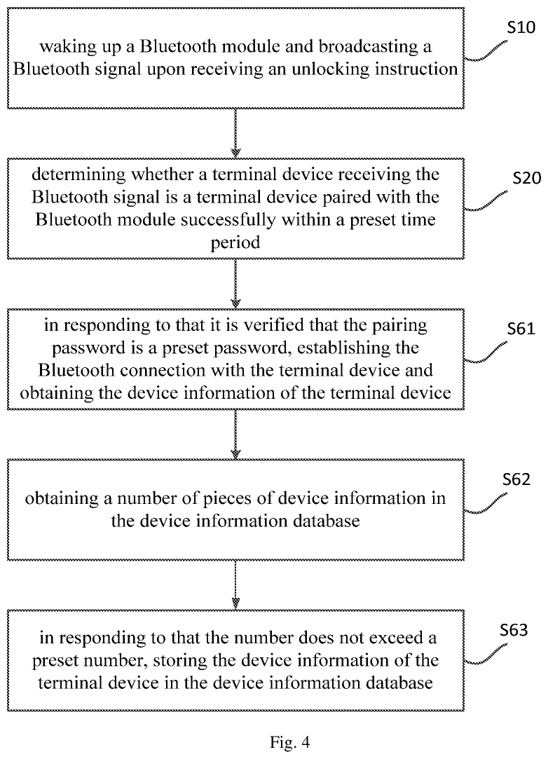

Referring to FIG. 4, FIG. 4 is a flow diagram of a third embodiment of the intelligent unlocking method of the present application.

As shown in FIG. 4, in this embodiment, the above operation S60 includes:

Operation S61, in responding to that it is verified that the pairing password is a preset password, establishing the Bluetooth connection with the terminal device and obtaining the device information of the terminal device.

Operation S62, obtaining a number of pieces of device information in the device information database.

It should be noted that in order to improve the operation efficiency of the Bluetooth lock, the amount of the device information stored in the above device information database can be limited by a certain upper limit. In the specific implementation, the Bluetooth lock obtains the device information of the above terminal device after verifying that the pairing password is the preset password, and further obtain the number of pieces of device information stored in the information database.

Operation S63, in responding to that the number does not exceed a preset number, storing the device information of the terminal device in the device information database.

It is understandable that the above preset number can be set according to the actual storage capacity of the device information database.

In the specific implementation of this embodiment, when the number of pieces of device information stored in the device information database does not exceed the preset number, it means that at this time, the device information database can store more device information, and the Bluetooth lock stores the device information of the above terminal device in the device information database.

Further, in order to save hardware space and improve the operation efficiency of the Bluetooth lock, after the above operation S63, the method further includes:
in responding to that the number reaches the preset number, obtaining a storing timestamp corresponding to each piece of device information in the device information database.

It should be noted that when to store the device information of the terminal device, the Bluetooth lock can also store the storing timestamp corresponding to the device information together. The device information in the device information database can be sorted according to the corresponding storing timestamp. The sorting method can be that the earlier the storing timestamp is, the more forward the storing timestamp will be, or the later the storing timestamp is, the more forward the storing timestamp will, which is helpful for finding the Bluetooth lock.
determining an earliest stored piece of device information according to an order of storing timestamps; and
replacing the earliest stored piece of device information with the device information of the terminal device.

It should be noted that the above earliest stored device information can be the device information with the earliest timestamp stored in the device information database. For example, device information A, device information B and device information C are stored in the device information database. The storing timestamp corresponding to device information A is time 1, the storing timestamp corresponding to device information B is time 2, and the storing timestamp corresponding to device information C is time 3. Time 1 is earlier than time 2, time 2 is earlier than time 3, and the preset number set by the user is 3. At this time, the device information of the new terminal device is device information D. When the Bluetooth lock is to store the device information D in the device information database, because the device information database is full, the Bluetooth lock can delete the device information A corresponding to time 1 with the earliest storage time, store the device information D in the device information database, and record the storing timestamp as time 4.

In the specific implementation, when the number of pieces of the device information in the device information database reaches the preset number, the Bluetooth lock can obtain the storing timestamp corresponding to each piece of device information in the device information database, select the earliest stored device information in the device information database according to the storing timestamp, and replace the earliest stored device information with the device information of the above terminal device, the operation efficiency and the security are both improved.

In this embodiment, after verifying that the pairing password is the preset password, the Bluetooth lock obtains the device information of the above terminal device, and obtains the number of pieces of device information stored in the information base. When the number reaches the preset number, the Bluetooth lock can obtain the storing timestamp corresponding to each piece of device information in the device information database, and select the device information earliest stored in the device information database according to the storing timestamp, and replace the earliest stored device information with the device information of the above terminal device. Thus, the operation efficiency and the security are both improved.

In addition, the embodiment of the present application also proposes a storage medium, on which an intelligent unlocking program is stored. When the intelligent unlocking program is executed by the processor, operations of the intelligent unlocking method as described above are realized.

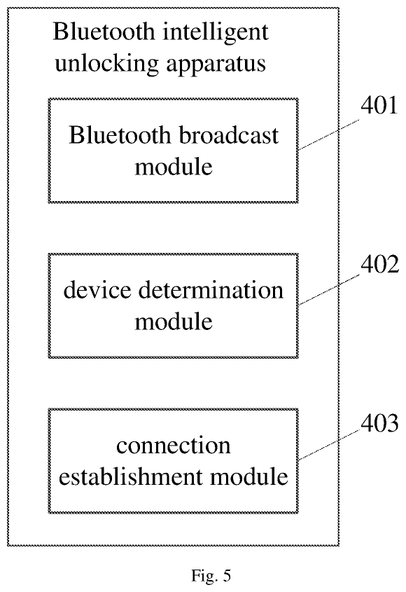

Referring to FIG. 5, FIG. 5 is a structural block diagram of a first embodiment of the intelligent unlocking apparatus of the present application.

As shown in FIG. 5, the intelligent unlocking apparatus proposed in the embodiment of the present application includes:
a Bluetooth broadcast module 401 for waking up a Bluetooth module and broadcasting a Bluetooth signal upon receiving an unlocking instruction;
a device determination module 402 for determining whether a terminal device receiving the Bluetooth signal is a terminal device paired with the Bluetooth module successfully within a preset time period;
a connection establishment module 403 for in responding to that the terminal device receiving the Bluetooth signal is the terminal device paired with the Bluetooth module successfully within the preset time period, establishing a Bluetooth connection with the terminal device, and changing the Bluetooth module to a sleep state after a Bluetooth lock is opened.

In the present application, when the unlocking instruction is not received, the Bluetooth module is in a sleep state, that is, power supply to the Bluetooth module is stopped. When the unlocking instruction is received, supply power to the Bluetooth module is resumed to wake up the Bluetooth module and broadcast the Bluetooth signal. At this time, the indicator light of the prompt module flashes slowly according to a certain time interval. If the terminal device is detected during broadcasting, the device information of the terminal device receiving the Bluetooth signal is obtained, the device information is compared with the device information database inside the Bluetooth lock. When the device information is stored in the device information database, the Bluetooth lock establishes a Bluetooth connection with the terminal device. At this time, the indicator light of the prompt module becomes always on. At the same time, after the Bluetooth lock is opened, the Bluetooth module enters the sleep state, so that when the unlocking instruction is not received in the present application, the Bluetooth lock is in the sleep state. Upon receiving the unlocking instruction, the Bluetooth module of the Bluetooth lock starts broadcasting the Bluetooth signal and establishes a Bluetooth connection with the terminal device. After the Bluetooth lock is opened, the Bluetooth module is changed to the sleep state to reduce power consumption, and the Bluetooth lock wakes up the Bluetooth module to broadcast only when the user needs to unlock, and changes the Bluetooth module to the sleep state to save power resource when the user doesn't need to unlock. At the same time, considering that the Bluetooth lock needs to add a pairing device, upon determining that the terminal device receiving the Bluetooth signal does not belong to the preset information database, the Bluetooth lock sends a Bluetooth pairing prompt to the above terminal device for pairing. If the user needs the encryption, the window sent by the Bluetooth lock to the terminal device is an encryption window with a preset encryption means, and the user encrypts the pairing password through the encryption window, then the encrypted result is fed back to the Bluetooth lock. The Bluetooth lock decrypts the feedback result according to the decryption method corresponding to the preset encryption method, obtains the decrypted password, and then verifies the decrypted password according to the preset password. When the verification is passed, the Bluetooth connection with the above terminal device is established, and the device information of the terminal device is stored in the device information database. Thus, the security of the Bluetooth lock is improved. After verifying that the pairing password is the preset password, the device information of the above terminal device is obtained, and the number of pieces of device information stored in the information base is obtained. When the number reaches the preset number, the Bluetooth lock can obtain the storing timestamp corresponding to each piece of device information in the device information database, and select the device information earliest stored in the device information database according to the storing timestamp, and replace the earliest stored device information with the device information of the above terminal device. Thus, the operation efficiency and improve the security are both improved.

Other embodiments or specific implementation methods of the intelligent unlocking device of the present application can refer to the above method embodiments, which will not be repeated here.

It should be noted that herein the terms “include”, “comprise” or any other variation thereof are intended to cover nonexclusive inclusion, so that a process, method, article or system including a series of elements includes not only those elements, but also other elements not explicitly listed, or elements inherent in such a process, method, article or system. Without further restrictions, the element defined by the statement “including a . . . ” does not exclude the existence of other identical elements in the process, method, article or system including the element.

The above serial number of the embodiment of the present application is only for description and does not represent the advantages and disadvantages of the embodiment.

Through the description of the above embodiments, those skilled in the art can clearly understand that the above embodiment method can be realized by means of software and necessary general hardware platform. Of course, it can also be realized by hardware, but in many cases, the former is better. Based on this understanding, the technical solution of the present application, in essence or the part that contributes to the related art, can be embodied in the form of a software product, which is stored in a storage medium (such as a read-only memory/random access memory, a magnetic disc, an optical disc), a plurality of commands are included to enable a terminal device (which can be a mobile phone, a computer, a server, an air conditioner, or a network device) to execute the method described in various embodiments of the present application.

The above is only the preferred embodiment of the present application and does not limit the claimed scope of the present application. All equivalent structure or process transformations made by using the contents of the description and attached drawings of the present application, or any direct or indirect application in other relevant technical fields, are similarly included in the claimed scope of the present application.

What is claimed is:

1. An intelligent unlocking method, comprising:
waking up a Bluetooth module and broadcasting a Bluetooth signal upon receiving an unlocking instruction;
determining whether a terminal device receiving the Bluetooth signal is a terminal device paired with the Bluetooth module successfully within a preset time period; and
in responding to that the terminal device receiving the Bluetooth signal is the terminal device paired with the Bluetooth module successfully within the preset time period, establishing a Bluetooth connection with the terminal device, and changing the Bluetooth module to a sleep state after a Bluetooth lock is opened.

2. The intelligent unlocking method according to claim 1, wherein the determining whether the terminal device receiving the Bluetooth signal is the terminal device paired with the Bluetooth module successfully within the preset time period comprises:
obtaining device information of the terminal device receiving the Bluetooth signal; and
determining whether the device information is stored in a device information database, wherein the device information database stores device information of terminal devices paired successfully with the Bluetooth module within the preset time period.

3. The intelligent unlocking method according to claim 2, after the determining whether the terminal device receiving the Bluetooth signal is the terminal device paired with the Bluetooth module successfully within the preset time period, further comprising:
in responding to that the terminal device receiving the Bluetooth signal is not the terminal device paired with the Bluetooth module successfully within the preset time period, sending a Bluetooth pairing prompt to the terminal device receiving the Bluetooth signal;
obtaining a pairing password fed back by the terminal device based on the Bluetooth pairing prompt, and verifying the pairing password; and
in responding to that the pairing password is validated, establishing the Bluetooth connection with the terminal device, and storing the device information of the terminal device in the device information database.

4. The intelligent unlocking method according to claim 3, wherein the in responding to that the pairing password is validated, establishing the Bluetooth connection with the terminal device, and storing the device information of the terminal device in the device information database comprises:
in responding to that it is verified that the pairing password is a preset password, establishing the Bluetooth connection with the terminal device and obtaining the device information of the terminal device;
obtaining a number of pieces of device information in the device information database; and
in responding to that the number does not exceed a preset number, storing the device information of the terminal device in the device information database.

5. The intelligent unlocking method according to claim 4, after the obtaining the number of pieces of device information in the device information database, further comprising:
in responding to that the number reaches the preset number, obtaining a storing timestamp corresponding to each piece of device information in the device information database;
determining an earliest stored piece of device information according to an order of storing timestamps; and
replacing the earliest stored piece of device information with the device information of the terminal device.

6. The intelligent unlocking method according to claim 5, wherein the obtaining the pairing password fed back by the terminal device based on the Bluetooth pairing prompt and verifying the pairing password comprises:
obtaining the pairing password fed back by the terminal device based on the Bluetooth pairing prompt;
determining whether the pairing password is a plaintext password; and
verifying the pairing password according to the preset password in responding to that the pairing password is the plaintext password.

7. The intelligent unlocking method according to claim 6, after the determining whether the pairing password is the plaintext password, further comprising:
in responding to that the pairing password is an encryption password, decrypting the pairing password according to a preset encryption method to obtain the decrypted password, wherein the encryption password is obtained by the terminal device through the preset encryption method; and
verifying the decrypted password according to the preset password.

8. An intelligent unlocking device, comprising a memory, a processor and an intelligent unlocking program stored in the memory and executable by the processor, the intelligent unlocking program is configured to realize operations of the intelligent unlocking method according to claim 1.

9. A non-transitory storage medium storing an intelligent unlocking program is stored, when the intelligent unlocking program is executed by the processor, operations of the intelligent unlocking method according to claim 1 are realized.
